(19) United States
(12) Patent Application Publication
(10) Pub. No.: US 2026/0140095 A1
(43) Pub. Date: May 21, 2026

(54) SYSTEMS AND METHODS FOR SAMPLE ANALYSIS

(71) Applicant: Agilent Technologies, Inc., Santa Clara, CA (US)

(72) Inventors: Yue FANG, Santa Clara, CA (US); Lei CHEN, Santa Clara, CA (US); Bo-wen ZHU, Santa Clara, CA (US); Ming-Hao HE, Santa Clara, CA (US)

(73) Assignee: Agilent Technologies, Inc., Santa Clara, CA (US)

(21) Appl. No.: 19/359,352

(22) Filed: Oct. 15, 2025

Related U.S. Application Data
(63) Continuation-in-part of application No. PCT/CN2024/133326, filed on Nov. 20, 2024.

(51) Int. Cl. G01N 30/38; G01N 30/02; G01N 30/32

(52) U.S. Cl. CPC G01N 30/38; G01N 30/32; G01N 2030/025; G01N 2030/385

(57) ABSTRACT

Systems and methods for analysis of samples are described herein. The method can include providing a sample loop disposed between a first valve and a second valve. The method can include providing a pump disposed downstream of the second valve. The method can include providing a sample container disposed upstream of the first valve. The method can include engaging the pump at a first time to modify a pressure inside the sample loop from a first pressure to a second pressure less than the first pressure. The method can include opening the first valve at a second time subsequent to the first time to flow a sample through the first valve into the sample loop. The pump can be configured to remain fluidically connected to the sample loop and turned on at the second time.

### CROSS-REFERENCE TO RELATED APPLICATION

This application is a continuation-in-part of International Application No. PCT/CN2024/133326, filed Nov. 20, 2024, which is incorporated herein by reference in its entirety.

### TECHNICAL FIELD

The present application relates generally to gas chromatography, including micro gas chromatography.

### BACKGROUND

Analytical separation techniques can include liquid chromatography (LC) or gas chromatography (GC). Gas chromatography is used to analyze and detect the presence of many different substances in a sample while in a gas phase. The function of a gas chromatograph is to separate the components of a chemical sample, known as analytes, and detect the identity and/or the concentration of those components. The separation is frequently accomplished using a capillary GC column. In some instances, this column is essentially a piece of fused silica tubing with a stationary phase coating on the inside that interacts with the sample to separate the components. A pressurized gas, known as the mobile phase, is used to push the sample through the column. The GC column can remain isothermal throughout an analysis or be ramped in temperature.

### SUMMARY

A gas chromatography (e.g., micro gas chromatography) system that uses a membrane valve for sampling may encounter issues such as an inability to sample (e.g., fill a sample loop with sample in order to inject a known quantity of sample onto a column for analysis) samples stored at a negative pressure. Gases downstream of the membrane valve may dilute or contaminate the sample if the sample has a pressure less than or equal to the pressure downstream of the sample valve opened during sampling. For example, when the sample valve is opened, gases downstream of the sample valve, such as those residing in a sample loop, can flow into the sample container and dilute and/or contaminate the sample. If the pressure of the sample is sufficiently low, the normally-open membrane valve may be pulled closed if no additional forces are applied to the membrane to overcome the negative pressure of the sample flow path.

The systems and methods of the present disclosure can address these and other issues by delaying the opening time of the sample valve relative to fluidically connecting a pump to the sample loop and letting the pump partially remove residual tail gas downstream of the valve. The pump can remain fluidically connected with the sample loop when the sample valve is opened. In some embodiments, such as for sufficiently negative pressure samples, an additional pump can be used in the valve control flow path to assist with opening the membrane valve.

At least one aspect of the present disclosure is directed to a method for a gas chromatography system. The method can include providing a sample loop disposed between a first valve and a second valve. The method can include providing a pump disposed downstream of the second valve. The method can include providing a sample container disposed upstream of the first valve. The method can include engaging the pump at a first time to modify a pressure inside the sample loop from a first pressure to a second pressure less than the first pressure. The second valve can be positioned such that the pump is fluidically connected with the sample loop at the first time. The method can include opening the first valve at a second time subsequent to the first time to flow a sample through the first valve into the sample loop. The pump can be configured to remain fluidically connected to the sample loop and turned on at the second time.

Another aspect of the present disclosure is directed to a non-transitory computer-readable medium for use with a gas chromatography system. The gas chromatography system can include a sample loop disposed between a first valve and a second valve. The gas chromatography system can include a pump disposed downstream of the second valve. The gas chromatography system can include a sample container disposed upstream of the first valve. The medium can have computer-readable instructions stored thereon that, when executed by at least one controller, cause the at least one controller to engage the pump at a first time to modify a pressure inside the sample loop from a first pressure to a second pressure less than the first pressure. The second valve can be positioned such that the pump is fluidically connected with the sample loop at the first time. The at least one controller can be configured to open the first valve at a second time subsequent to the first time to flow a sample through the first valve into the sample loop. The pump can remain fluidically connected to the sample loop and turned on at the second time.

Those skilled in the art will appreciate that the summary is illustrative only and is not intended to be in any way limiting. Other aspects, inventive features, and advantages of the devices and/or processes described herein, as defined solely by the claims, will become apparent in the detailed description set forth herein and taken in conjunction with the accompanying drawings.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 is a schematic diagram of a gas chromatography system in accordance with an embodiment.

FIG. 2 is a schematic diagram of a gas chromatography system in accordance with an embodiment.

FIG. 3 is a schematic diagram of a gas chromatography system in accordance with an embodiment.

FIG. 4 is a schematic diagram of a gas chromatography system in accordance with an embodiment.

FIG. 5 is a schematic flow diagram illustrating a method for analysis of samples in accordance with an embodiment.

Like reference numbers and designations in the various drawings indicate like elements.

### DETAILED DESCRIPTION

Following below are more detailed descriptions of various concepts related to, and implementations of, methods, apparatuses, and systems for analysis of samples stored at negative or positive pressure. The various concepts introduced above and discussed in greater detail below may be implemented in any of a number of ways, as the described concepts are not limited to any particular manner of implementation. Examples of specific implementations and applications are provided primarily for illustrative purposes.

During operation of a micro gas chromatography system, gas samples stored at a negative pressure may become diluted or contaminated with downstream gases. This may be caused by the pressure of the sample being lower than the pressure of the flow path downstream of the sample, including the sample loop. Therefore, the gases downstream of the sample, which are at a higher pressure than that of the sample, may be driven to flow upstream to the sample, thereby diluting and/or contaminating the sample during the sampling process.

The present disclosure is directed to systems and methods for analysis of samples stored at negative or positive pressure. Analysis of samples can include sampling samples. The disclosed solutions have a technical advantage of allowing for sample analysis by micro gas chromatography on negative pressure samples using a membrane valve and sample loop. High negative pressure sampling can be achieved by delaying the opening of the membrane valve after a pump has been engaged with the sample loop. Low negative pressure sample analysis can be achieved by adding a second pump configured to assist with opening the membrane valve. The solutions can prevent the sample from becoming diluted and/or contaminated during sampling.

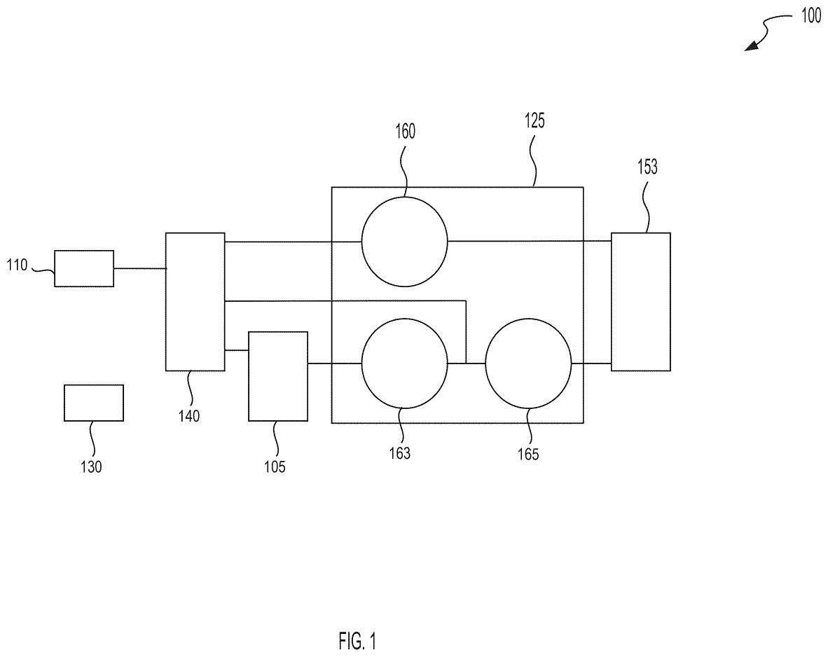

FIG. 1 is a schematic diagram of a gas chromatography system 100. The GC system 100 can include a representative GC system. The GC system 100 can include a gas chromatograph (GC). The GC system 100 can include a micro GC system (e.g., micro gas chromatography system).

The GC system 100 can include one or more injectors 105 (e.g., injection port, inlet, sample inlet). The injector 105 can receive a sample to be injected into the GC system 100 for analysis. For example, the sample can be injected into the injector 105 where, if not already in a gaseous state, it is vaporized into the gaseous state for analysis by the GC system 100. The injector 105 can be heated. Sampling can occur at the injector 105.

During an injection operation of the injector 105 for micro GC, a valve (e.g., sample valve) located between the sample container and sample loop can be opened to put the sample into fluidic communication with a sample loop. The sample loop can include a tube or cavity of known volume. A pump connected to the other end of the sample loop can assist with pulling the sample into the sample loop to fill (e.g., completely fill) the sample loop with sample. Then, the sample valve between the sample loop and the sample container can be closed and an inject valve between the sample loop and the column can be opened to put the sample loop in fluidic connection with the column while a pump valve (e.g., a 3-way, 2-position switching valve) is being switched to remove the sample loop from fluidic communication with the pump and to fluidically connect the sample loop to a source of pressurized carrier gas that can push the sample gas in the sample loop onto the column. The carrier gas can push the sample gas in the sample loop in the opposite direction of how the sample loop was filled. The injection operation can result in a precise and accurate volume of sample being injected onto the column for analysis. Precision and accuracy can be needed for repeatability from one analysis to another and across instruments. If the sample gets diluted during this sampling process, then the sample loop can fill with diluted sample rather than pure sample, which may result in an unknown amount of sample being injected onto the column. The sample valve and the inject valve can be membrane valves (e.g., diaphragm valves) for chemical compatibility and low dead volume purposes. The sample valve and the inject valve are in the sample flow path.

The GC system 100 can include one or more carrier gas sources 110 (e.g., pressurized gas supply, pressurized gas source, pressurized carrier gas source, gas source, gas supply, supply gas, carrier gas supply, carrier gas). The carrier gas source 110 can include a tank. The carrier gas source 110 can be fluidly (e.g., fluidically) coupled with (e.g., connected to, connected with) the injector 105. The carrier gas source 110 can supply a carrier gas, such as but not limited to, helium, hydrogen, nitrogen, an argon/methane mixture, or other such inert gas, that transports the injected sample from the injector 105 through the GC system 100. The carrier gas source 110 can include a source of pressurized gas. The carrier gas source 110 can be a gas distribution system of pressurized gases. The pressurized gases can be found in a laboratory. The carrier gas source 110 can include multiple gases. The carrier gas source 110 can be coupled with the GC system 100 via a distribution panel. The carrier gas source 110 can include a cannister of pressurized gas. The carrier gas source 110 can be portable.

The GC system 100 can include a flow control system 140 (e.g., flow control module). The flow control system 140 can include the one or more carrier gas sources 110, one or more pumps, and one or more valves. The one or more carrier gas sources 110, the one or more pumps, and/or the one or more valves can be configured to control the flow of carrier gas and/or sample throughout the GC system 100. The flow control system 140 can be coupled with (e.g., connected to) the carrier gas source 110. The flow control system 140 can be coupled with the injector 105. The flow control system 140 can control the flow and/or pressure of the injector 105.

The GC system 100 can include one or more columns (e.g., tube, restrictor, separation column). The column can be fluidly coupled with the injector 105. The column can be coupled with the flow control system 140. The column can be selected from a wide variety of columns utilized to achieve separation of components of a sample by gas chromatography. Gas chromatographs configured for backflushing, detector splitting, or other pneumatic switching can include multiple columns. The carrier gas can transport the sample from the injector 105 to the column for separation. The column can separate the components of the gaseous sample to produce one or more analytes of interest for analysis by the GC system 100. The column can include a capillary column and/or may include fused silica tubing with a coating (e.g., stationary phase coating) on the inner portions of the tubing that interacts with the sample injected into the injector 105 to separate the components of the sample. The column can be made of metal. Dimensions of the column can include an inner diameter range of 50 μm (microns) to 530 μm and a length range of up to 200 meters. The injector 105 can provide samples to the column for separation.

The column can include a separation column or a column that serves as a restrictor fluidically connected to (e.g., in fluidic communication with) a separation column. The column can include a reference column 160. The reference column 160 can have carrier gas flowing through it. The reference column 160 can be fluidically connected with the carrier gas source 110. The column can include a pre-column 163. The pre-column 163 can be fluidically connected with the carrier gas source 110. The pre-column 163 can be used for backflushing out contaminants after the analytes of interest have been passed through. The column can include an analytical column 165. The analytical column 165 can be fluidically connected with the carrier gas source 110. The pre-column 163 and the analytical column 165 can have sample and carrier gas flowing through them during an analysis. The pre-column 163 and the analytical column 165 can separate the analytes of the sample. This can allow the detector signals for the reference column 160 and the analytical column 165 to be compared to subtract out the baseline, resulting in noise reduction. The pre-column 163 can be used for backflushing out contaminants after the analytes of interest have passed through.

The GC system 100 can include one or more column heaters 125. The column heater 125 can include a conduction heater. In some embodiments, the column heater 125 can include an oven, a convection heater, an air bath, or other such heating device for heating certain components of the GC system 100. The column heater 125 can heat or cool the column and other flow path components to desired temperatures. The column heater 125 can be configured to heat the column such that the column remains isothermal during sample analysis.

The GC system 100 can include one or more controllers 130. The controller 130 can be communicably connected, directly or indirectly, to the column heater 125, the injector 105, one or more sensors, and/or other components of the GC system 100. The controller 130 can be electrically coupled with the GC system 100. The controller 130 can be an onboard computing component that is physically incorporated into the housing of the GC system 100 that contains the column, column heater 125, and other components of the GC system 100. The controller 130 can be one or more separate computing devices and/or other such controlling devices that are internal and/or external to the housing of the GC system 100. The controller 130 or a portion of the controller 130 can reside within the GC system 100. For example, the controller 130 or a portion of the controller 130 can be disposed in the GC system 100. The controller 130 can be split between multiple locations. The controller 130 can be disposed outside of the GC system 100.

The controller 130 can include one or more processors, such as but not limited to, a single-core processor, a multi-core processor, a logic device, or other such data processing circuitry, configured to execute, analyze, and process data and information of the GC system 100. The controller 130 can include a non-transitory memory device communicably connected to the processor. The memory device may be configured as a volatile memory device (e.g., SRAM and DRAM), a non-volatile memory device (e.g., flash memory, ROM, and hard disk drive), or any combination thereof. The memory device may store executable code and other such information that is generated and/or processed by the processor during operation of the GC system 100.

The GC system 100 can include one or more input/output devices communicably connected to the controller 130. The input/output device can enable an operator and/or user to receive information from the controller 130 and to input information and parameters into the controller 130. Such information and parameters can be stored in the memory device, accessed by the processor, and output to the input/output device. For example, the input/output device can include a monitor, display device, touchscreen device, keyboard, microphone, joystick, dial, button, or other such device to enable input and output of information and parameters. The input/output device may be utilized to input information into the controller 130 and output or otherwise display information and data generated by the processor of the GC system 100.

The GC system 100 can include a detector 153. The detector 153 can be disposed in the GC system 100. For example, the detector 153 can be partially disposed in the GC system 100. The detector 153 can be fluidically connected to the column. The detector 153 can be fluidically connected to the carrier gas source 110. The detector 153 can include a thermal conductivity detector (TCD). The detector 153 can include a heater. The detector 153 can respond to one or more compounds. The detector 153 can respond to the carrier gas, but the response can be subtracted out by comparing the signal of the carrier gas coming through the reference column 160. The detector 153 can be used for analysis of samples. The detector 153 can create an electrical signal in response to an analyte passing through the detector 153 due to the difference in thermal conductivity of the analyte relative to the carrier gas. The detector 153 can be fluidically connected with the reference column 160. The detector 153 can be fluidically connected with the pre-column 163. The detector 153 can be fluidically connected with the analytical column 165.

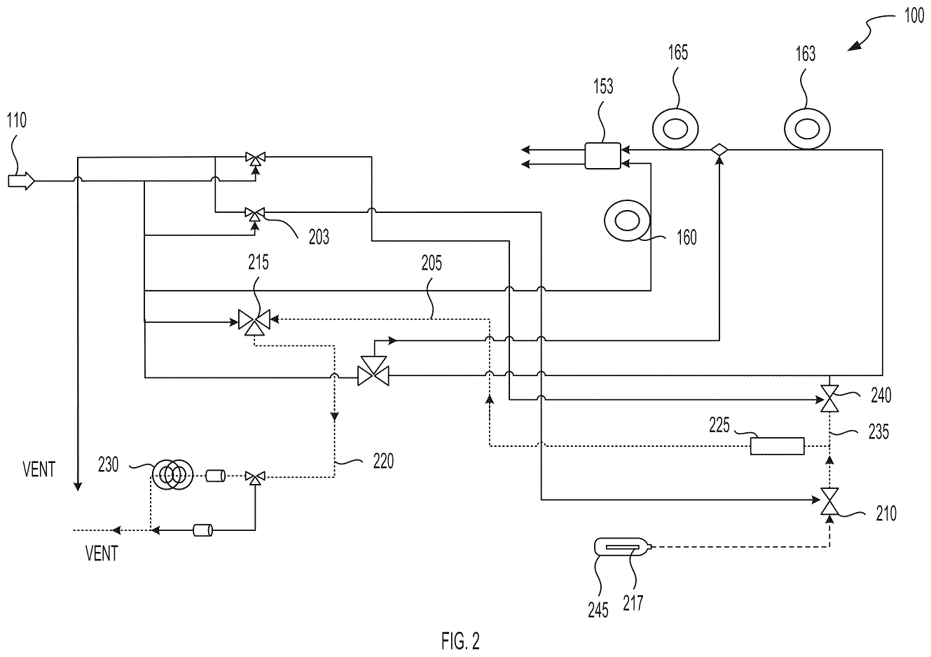

FIG. 2 is a schematic diagram of the GC system 100. The GC system 100 can include a sample container 245 (e.g., vessel, sample source, container, tank). The sample container 245 can include a bottle (e.g., glass bottle). A sample 217 (e.g., gas sample) can be disposed in the sample container 245. The sample 217 can be in a gas phase in the sample container 245. The sample container 245 can remain stationary while the sample 217 can flow through the GC system 100. The pressure of the sample 217 can change as the sample 217 flows through the GC system 100. The sample 217 can include a negative pressure sample. The negative pressure sample can include the sample 217 stored in a container at a pressure below ambient pressure (e.g., atmospheric pressure). Ambient pressure can be about 100 kPa (e.g., 101,325 Pa) at sea level. The negative pressure sample can include a low negative pressure sample. The low negative pressure sample can include the sample 217 stored in a container at a pressure below a threshold pressure. The negative pressure sample can include a high negative pressure sample. The high negative pressure sample can include the sample 217 stored in a container at a pressure above the threshold pressure. The sample 217 can include a positive pressure sample. The positive pressure sample can include the sample 217 that is stored in a container at a pressure above ambient pressure. The sample container 245 can house the sample 217.

The GC system 100 can include a sample valve 210 (e.g., first valve). The sample valve 210 can include a membrane valve (e.g., diaphragm valve, gas-actuated diaphragm valve). The sample valve 210 can be fluidically connected to the sample container 245. The sample valve 210 can be disposed downstream of the sample container 245. The sample container 245 can be disposed upstream of the sample valve 210. The sample valve 210 can include a “normally-open” valve. The sample valve 210 can be controlled by gas, rather than by electricity. The opening and closing of the sample valve 210 can be controlled by the gas (e.g., compressed air, carrier gas, pressurized carrier gas). The sample valve 210 can be in the sample flow path. The membrane valve can have a diaphragm, an inlet, and an outlet. The diaphragm can separate a first side of the membrane valve from a second side of the membrane valve. The first side of the membrane valve can include the inlet and the outlet. The inlet and the outlet can be part of the sample flow path. The first side of the membrane valve can include the sample flow path.

The membrane valve can have a control flow path (e.g., valve control flow path). The second side of the membrane valve can include the control flow path. The valve control flow path is not fluidically connected to the sample flow path. The pressure in the valve control flow path can be altered to open or close the membrane valve by pushing the membrane (e.g., diaphragm) into contact with the valve seat or vice versa. In some embodiments, the membrane valve is a normally-open valve. A normally-open valve can be a valve in which when there is no pressure differential between the sample flow path and the valve control flow path, the valve is open such that the inlet and outlet are in fluidic communication. A valve 203 can switch from the valve control flow path either being connected to the carrier gas source 110 or open to ambient pressure.

The GC system 100 can include a sample loop 225 (e.g., cavity, tube). The sample loop 225 can be filled with the sample 217. The sample loop 225 can include a groove engraved on an injector die. The sample loop 225 can have a volume of 10 μL. The volume of the sample loop 225 can be less than or greater than 10 μL. The injector 105, the sample loop 225, and sample valve 210 can be disposed on a silicon chip. The sample loop 225 can be disposed downstream of the sample valve 210. The sample valve 210 can be disposed upstream of the sample loop 225. The sample loop 225 can be disposed downstream of the sample container 245. The sample container 245 can be disposed upstream of the sample loop 225. The sample valve 210 can be disposed between the sample container 245 and the sample loop 225. The sample loop 225 can be attached directly to the sample valve 210. The sample loop 225 can include a conduit. For example, the sample loop 225 can include a conduit with a predetermined (e.g., accurate, precise) volume. The sample loop 225 can be in the sample flow path. The negative pressure sample can include the sample 217 stored in a container at a pressure below the pressure of the sample loop 225. The positive pressure sample can include the sample 217 stored in a container at a pressure above the pressure of the sample loop 225.

The GC system 100 can include a first pump 230. The first pump 230 can include a vacuum pump. The first pump 230 can maintain a steady vacuum level. The first pump 230 can include a peristaltic pump, rotary pump, and/or diaphragm pump. The first pump 230 can be configured to evacuate (e.g., remove) gas and/or contaminants from a portion of the GC system 100. The first pump 230 can engage in a pre-evacuation operation (e.g., procedure, protocol). This can partially or substantially remove the gas in the sample loop 225. The first pump 230 can partially or substantially remove the gas downstream of the sample valve 210. The first pump 230 can pump gases out of the GC system 100. The first pump 230 can partially remove the gases in the sample loop 225 downstream of the sample valve 210. The first pump 230 can substantially remove the gases in the sample loop 225 downstream of the sample valve 210. The first pump 230 can pump (e.g., pull) the sample 217 into the sample loop 225 when the sample valve 210 is open. The first pump 230 can modify a pressure inside the sample loop 225. For example, the first pump 230 can modify the pressure inside the sample loop 225 from a first pressure to a second pressure. The second pressure can be less than the first pressure.

The GC system 100 can include a pump valve 215 (e.g., second valve). The pump valve 215 can include a switching valve (e.g., a 3-way, 2-position switching valve). The pump valve 215 can include a solenoid valve. A 3-way, 2-position switching valve can include a valve that has two positions and three inlets/outlets. For example, the pump valve 215 can be configured such that the first pump 230 or the carrier gas source 110 is fluidically connected to the sample loop 225. This can depend on whether the sample 217 is being pulled into the sample loop 225 by the first pump 230 during sampling or pushed out of the sample loop 225 and onto the column by the carrier gas during injection. The pump valve 215 can be configured such that in a first state, the sample loop 225 and the first pump 230 are fluidically connected. For example, the pump valve 215 can be open to the first pump 230 and the sample loop 225. In the first state, the sample loop 225 can be filled with the sample 217. The first pump 230 can pull the sample 217 into the sample loop 225 during filling of the sample loop 225. The pump valve 215 can be configured such that in a second state, the sample loop 225 and the carrier gas source 110 are fluidically connected. For example, the pump valve 215 can be open to the sample loop 225 and the carrier gas source 110. In the second state, the carrier gas can push the sample 217 from the sample loop 225 onto the column. The pump valve 215 can be attached directly to the sample loop 225.

The GC system 100 can include an inject valve 240 (e.g., third valve). The inject valve 240 can include a membrane valve (e.g., diaphragm valve, gas-actuated diaphragm valve). The inject valve 240 can be opened during the injection operation. During the injection operation, carrier gas can be used to push the sample 217 from the sample loop 225 onto the column. The injection volume of the sample 217 can be controlled by the injection time. The inject valve 240 can be fluidically connected to the sample loop 225. The inject valve 240 can be fluidically connected to the sample valve 210. The inject valve 240 can be disposed downstream of the sample valve 210. The sample valve 210 can be disposed upstream of the inject valve 240. The inject valve 240 can be fluidically connected to the column. The column can be disposed downstream of the inject valve 240. The inject valve 240 can be disposed upstream of the column. The inject valve 240 can be controlled by gas pressure, rather than by electricity. The inject valve 240 can be in the sample flow path.

During sampling, the sample 217 can move from the sample container 245 to the sample loop 225. If the pressure of the sample 217 in the sample container 245 is above the pressure in the sample loop 225 or ambient pressure before sampling occurs, the sample 217 can flow from the sample container 245 to the sample loop 225 without dilution or contamination of the sample in the sample container 245. However, if the pressure of the sample 217 in the sample container 245 is less than the pressure in the sample loop 225 and the first pump 230 is engaged at the same time or after the sample valve 210 is opened, contaminants or gases from downstream of sample valve 210 can flow into the sample container 245. When sampling begins, immediately before the sample valve 210 is opened and the first pump 230 is turned on, the lowest pressure that the sample loop 225 could be at is ambient pressure. If the first pump 230 is not turned on, then the sample loop 225 can be either open to atmosphere (e.g., connected to ambient, connected to vent) or connected to the carrier gas source 110. When the sample 217 in the sample container 245 is at or below ambient pressure, the sample 217 in the sample container 245 can become diluted because ambient pressure would be the lowest pressure the sample loop 225 could be without engaging the first pump 230 before opening the sample valve 210.

The pre-evacuation process can be implemented in which the first pump 230 is turned on (e.g., engaged, run) when the sample valve 210 is closed (e.g. before the sample valve 210 is opened during the sampling process), the pump valve 215 is in a state in which the first pump 230 is fluidically connected with the sample loop 225, and the inject valve 240 is closed. The pre-evacuation process can remove contaminants or gases from downstream of sample valve 210. The pre-evacuation process can lower the pressure of the sample loop 225. During the pre-evacuation process, the pump valve 215 can be in a state in which the sample loop 225 and the carrier gas source 110 are not fluidically connected. The first pump 230 can reduce the pressure in the sample loop 225. For example, the first pump 230 can reduce the pressure in the sample loop 225 to a pressure below the pressure in the sample container 245 such that gases do not backflow into the sample container 245. Reducing the pressure in the sample loop 225 can prevent gases from flowing towards the sample container 245 when the sample valve 210 is opened.

After the pre-evacuation process, a sampling process can be implemented in which the first pump 230 remains on, the sample valve 210 is opened, the pump valve 215 remains in a state in which the first pump 230 is fluidically connected with the sample loop 225, and the inject valve 240 remains closed. During the sampling process, the sample 217 can move from the sample container 245 to the sample loop 225. The first pump 230 can assist in filling the sample loop 225 with the sample 217 from the sample container 245 when the sample valve 210 is open. The first pump 230 can be engaged when the sample valve 210 is opened. The first pump 230 can be fluidically connected to the sample loop 225 when the sample valve 210 is opened. The sample 217 can be pulled into the sample loop 225 by the first pump 230, rather than solely due to a pressure differential between the sample container 245 and the sample loop 225 created during the pre-evacuation process. The first pump 230 can continue pumping after the sample valve 210 is opened to allow the sample 217 to reach the sample loop 225. The sample 217 may flow from the sample container 245 and through connecting pipelines and/or a sample inlet manifold before reaching the sample loop 225. A sufficient amount of the sample 217 can flow through the sample flow path to flush the sample flow path and realize accurate analyses. Without the first pump 230 continuing to pump, a negative pressure cavity created during the pre-evacuation process may not deliver and/or sustain the pressure differential needed to fill the sample loop 225 with a sufficient amount of sample 217. The pressure differential can decay quickly after the sample valve 210 is opened and the first pump 230 stops pumping. During the sampling process, the pump valve 215 can be in a state in which the sample loop 225 and the carrier gas source 110 are not fluidically connected.

After the sampling process, an injection process can be implemented in which the sample valve 210 is closed, the pump valve 215 is in a state in which the carrier gas source 110 is fluidically connected with the sample loop 225, and the inject valve 240 is opened. During the injection process, the pump valve 215 can be in a state in which the sample loop 225 and the first pump 230 are not fluidically connected, and the first pump 230 can be on or off during the injection process. During the injection process, the sample 217 can flow from the sample loop 225 to the column. For example, the carrier gas from the carrier gas source 110 can push the sample 217 from the sample loop 225 to the column. The inject valve 240 can be open to the column and the sample loop 225 during the injection process. The inject valve 240 can be open and the pump valve 215 can be in a state such that the carrier gas from the carrier gas source 110 can push the sample 217 to the column.

The GC system 100 can include one or more conduits (e.g., flow paths, channels, tubing) connecting the various components of the GC system 100. The various components of the GC system 100 can be attached/connected via the one or more conduits based on the location of the various components of the GC system 100 or due to extra volume/restrictions within the GC system 100. The components of the GC system 100 can be attached directly to neighboring components of the GC system 100 without a conduit in between. There can be additional flow paths connecting the sample loop 225 to the sample valve 210, the pump valve 215, and/or the inject valve 240. The GC system 100 can include a first conduit 205. The first conduit 205 can have a volume. The first conduit 205 can be disposed between the sample valve 210 and the pump valve 215. The first conduit 205 can be fluidically connected with the sample valve 210. The first conduit 205 can be fluidically connected with the pump valve 215. The pump valve 215 can be attached indirectly to the sample loop 225 via the first conduit 205. The first conduit 205 can accommodate excessive sample that flows through the sample loop 225 during sampling.

The GC system 100 can include a second conduit 220. The second conduit 220 can be disposed between the pump valve 215 and the first pump 230. The second conduit 220 can be fluidically connected with the pump valve 215. The second conduit 220 can be fluidically connected with the first pump 230. The second conduit 220 can be fluidically connected with the first conduit 205 when the pump valve 215 is in a state such that the first pump 230 and the sample loop 225 are fluidically connected. The pressure of the gas inside the second conduit 220 can be measured by a sensor.

The GC system 100 can include a third conduit 235. The third conduit 235 can be disposed between the sample valve 210 and the inject valve 240. The third conduit 235 can be fluidically connected with the sample valve 210. The third conduit 235 can be fluidically connected with the inject valve 240. The third conduit 235 can be connected to the sample loop 225. The third conduit 235 can be fluidically connected with the column when the inject valve 240 is open to the column and the sample loop 225. The third conduit 235 can be fluidically connected with the second conduit 220 when the pump valve 215 is open to the first pump 230 and the sample loop 225. The third conduit 235 can be fluidically connected with the carrier gas source 110 when the pump valve 215 is open to the first pump 230 and the sample loop 225. The pressure of the gas inside the third conduit 235 can be measured by a sensor. The sample valve 210 can be disposed between the sample container 245 and the third conduit 235. The sample valve 210 can close to prevent the sample 217 from flowing into the third conduit 235. The sample valve 210 can be opened to allow the sample 217 to flow into the third conduit 235.

The GC system 100 can include the detector 153 and the one or more columns (e.g., reference column 160, pre-column 163, and analytical column 165) described above. The analytical column 165 can be fluidically connected to the sample loop 225 when the inject valve 240 is open. For example, the analytical column 165 can be fluidically connected to the sample loop 225 during pushing of the sample 217 from the sample loop 225 onto the analytical column 165 when the inject valve 240 is open.

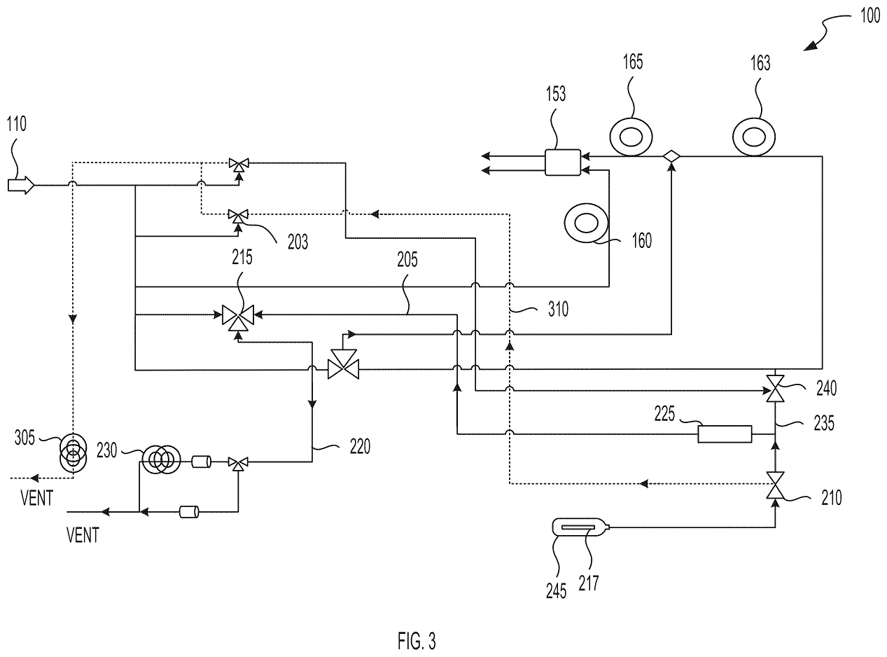

FIG. 3 is a schematic diagram of the GC system 100. The GC system 100 can include the carrier gas source 110, the detector 153, the first conduit 205, the sample valve 210, the sample container 245, the sample 217, the sample loop 225, the second conduit 220, the pump valve 215, the first pump 230, the third conduit 235, the inject valve 240, the valve 203, the reference column 160, the pre-column 163, and the analytical column 165.

The sample valve 210 can include a membrane valve. If the pressure on the first side of the membrane valve and the second side of the membrane valve are equal or if the pressure in the valve control flow path is lower or only slightly higher than that of the sample flow path, the membrane valve can rest in a normally open state. Pressurized gas in the valve control flow path can be used to close the membrane valve. The minimum pressure in the valve control path can be ambient pressure (e.g., opening the membrane valve to the atmosphere) without the use of a pump on the valve control flow path.

However, in some situations, the pressure in the sample flow path can be much lower than ambient pressure (e.g., for low negative pressure samples). Therefore, the pressure in the sample flow path can be much lower than the pressure achievable in the valve control flow path when only using pressurized carrier gas or a vent to atmosphere. In these situations, even ambient pressure in the valve control flow path will not cause the membrane valve to open because the differential in pressure between the valve control flow path and sample flow path is too large that the diaphragm gets pulled closed. The pressure difference across the membrane of the membrane valve can open or close the membrane valve.

The pre-evacuation operation can be used for the high negative pressure sample. The high negative pressure sample can include the sample 217 stored in a container with a pressure above a threshold pressure (e.g., threshold pressure value, threshold value) and below ambient pressure or the pressure of the sample loop 225. High negative pressure can be in a range of above the threshold pressure to ambient pressure. High negative pressure can be in a range of above the threshold pressure to the pressure of the sample loop. The pre-evacuation operation can be used for the low negative pressure sample. The low negative pressure sample can include the sample 217 stored in a container with a pressure below the threshold pressure. Low negative pressure can be in a range of below the threshold pressure to vacuum pressure. The pre-evacuation operation can be used for the positive pressure sample. The positive pressure sample can include the sample 217 stored in a container with a pressure above ambient pressure or the pressure of the sample loop 225.

If the pressure of the sample 217 in the sample container 245 is below the threshold pressure, the sample valve 210 may not open easily. Below the threshold pressure, the sample valve 210 may not open without application of additional force. The flexibility or elasticity of the membrane of the sample valve 210 can determine the threshold pressure that the sample valve 210 can open against without additional assistance. The threshold pressure can depend on the elasticity of the membrane of the sample valve 210 and the pressure in the valve control flow path. When the valve control flow path is either open to the atmosphere or connected to the carrier gas source 110, the minimum pressure in the valve control flow path is ambient pressure. Below the threshold pressure, the sample valve 210 can close automatically (e.g., without application of additional force).

The GC system 100 can include a second pump 305 (e.g., pump for controlling the opening of the membrane valves). The second pump 305 can assist in opening the sample valve 210 when low negative pressure samples are contained in the sample container 245. The second pump 305 can include a vacuum pump. For example, the second pump 305 can include a diaphragm vacuum pump and/or a rotary vacuum pump. The second pump 305 can be fluidically connected to the sample valve 210. The second pump 305 can open the sample valve 210. For example, the second pump 305 can be engaged to open the sample valve 210. The second pump 305 can control the opening of the sample valve 210. The control flow path of the sample valve 210 can be fluidically separated from the sample flow path of the sample valve 210. The second pump 305 can lower the pressure in the control flow path to a pressure below ambient pressure. When the control flow path is either connected to the second pump 305 or the carrier gas source 110, the minimum pressure in the control flow path is the pressure that can be achieved by the second pump 305. The second pump 305 can provide sufficiently low negative pressure to the sample valve 210 to open the sample valve 210. For example, the second pump 305 can provide sufficiently low negative pressure to the sample valve 210 to open the sample valve 210 when the sample valve 210 is fluidically connected with a low negative pressure sample. A combination of the flexibility of the membrane of the sample valve 210 and the pressure in the sample flow path can determine whether or not an additional pump (e.g., second pump 305) is needed to open the sample valve 210.

The threshold pressure can depend on the stiffness or elasticity of the membrane of the sample valve 210. The threshold pressure can be between −22 kPa and −27 kPa. For example, the threshold pressure can be −22 kPa, −23 kPa, −24 kPa, −25 kPa, −26 kPa, or −27 kPa. The elasticity of the membrane can determine the pressure differential needed to open the membrane valve and/or the threshold pressure for the sample flow path. A stiffer membrane can allow for a lower threshold pressure because it would take a larger pressure differential to move the membrane. However, a stiffer membrane may require a higher valve control flow path pressure to close the sample valve 210 if the pressure of the sample 217 in the sample container 245 is above ambient pressure.

To close the sample valve 210, the valve 203 can switch to having the carrier gas source 110 fluidically connected with the valve control flow path. The valve 203 can be in a state in which the carrier gas source 110 is in fluidic communication with the sample valve 210 to ensure the sample valve is closed. The second pump 305 can expand the range of pressures in the control flow path to go lower than ambient pressure when needed. If a higher pressure is needed to close the sample valve 210 fully and reliably, the valve 203 can switch from using the second pump 305 to using a pressurized gas (e.g., carrier gas). The closing of the sample valve 210 can be accomplished by switching the valve 203 (e.g., two position three-way solenoid valve) that controls the sample valve 210 to introduce pressurized carrier gas and push the membrane to the valve seat to help the sample valve 210 close.

The opening of the sample valve 210 can be accomplished by switching the valve 203 to the other state so that the control flow path is disconnected from the pressurized carrier gas and fluidically connected with the second pump 305. The second pump 305 can be used to open the sample valve 210 regardless of the sample pressure.

The GC system 100 can include a fourth conduit 310. The fourth conduit 310 can be disposed between the second pump 305 and the sample valve 210. The second pump 305 can be configured to open the sample valve 210. The fourth conduit 310 can be fluidically connected with the sample valve 210.

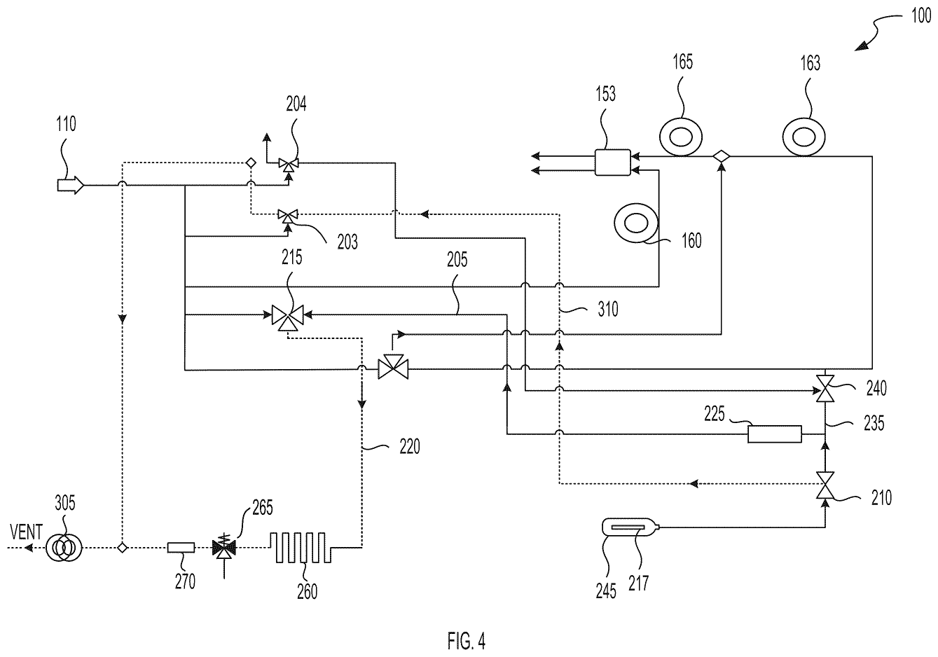

FIG. 4 is a schematic diagram of a gas chromatography system 100. Compared to the gas chromatography system 100 of FIG. 3, the gas chromatography system 100 of FIG. 4 illustrates an optional feature that combines the functionality of the first pump 230 into the second pump 305 (as shown in the system 100 of FIG. 3), allowing for the first pump 230 to be eliminated. The second pump 305 can serve to both open the injection valve 210 as well as pull the negative pressure sample 217 into sample loop 225 during the sampling process. Combining the functionality of the first pump 230 and the second pump 305 into the second pump 305 can result in cost savings and increased reliability for the system 100.

A second option shown in FIG. 4 includes a sample volume 260 (e.g., sample cache) fluidically connected to the second conduit 220 and second pump 305 (or the first pump 230 if two pumps are used for controlling the valves and filling the sample loop 225 as in the system 100 of FIG. 3). The sample volume 260 can provide an additional volume to increase the total volume of the second conduit 220 for the filling of the sample loop 225. The sample volume 260 can provide a buffer space to prevent contaminants downstream of the sample loop 225 from flowing towards the sample loop 225 when the injection valve 210 is opened during the sampling process and the sample loop 225 is exposed to the negative pressure sample 217. This can increase the amount of sample 217 that is able to flow into sample loop 225. The sample volume 260 can be any container capable of containing a gas known to those skilled in the art. For example, the sample volume 260 may be a tube or container having an internal diameter in a range of 0.25 mm to 2.0 mm. The sample volume 260 may be made of plastic, metal, or any materials and wall thicknesses that can withstand pressure differences of 100 kPa. The volume of the sample volume 260 may be chosen based on system parameters, for example, the pressure of sample 217, the pressure downstream of sample volume 260, the injection time, and the sample type. The sample volume 260 can have a volume in a range of 60 μL to 6000 μL.

A third option shown in FIG. 4 includes a restriction 270 in the sample flow path for the filling of the sample loop 225. The restriction 270 can be located downstream of the sample loop 225 and upstream of the second pump 305 (or upstream of the first pump 230 if two pumps are used for controlling the valves and filling the sample loop 225 as in the system 100 of FIG. 3). The restriction 270 can be fluidically connected to the second conduit 220, the second pump 305, the sample volume 260, and/or the sample loop 225. The restriction 270 can provide flow resistance between the negative pressure sample 217 and the second pump 305 to preserve the sample pressure (e.g., limit the drop in pressure in the sample loop 225, the first conduit 205, and the second conduit 220 during the sampling process) while still allowing the sample 217 to flow through and fill the sample loop 225 during sampling. The restriction 270 can be a frit, a tube with a specified cross-section and length, or any other flow component that can cause a change in gas pressure between the inlet and outlet known to those skilled in the art.

A fourth option shown in FIG. 4 includes an equilibration valve 265 (e.g. fifth valve) added to the sample loop flow path upstream of the second pump 305 and downstream of sample loop 225 and sample volume 260. The equilibration valve 265 can be fluidically connected to the second conduit 220, the second pump 305 (or the first pump 230 if two pumps are used for controlling the valves and filling the sample loop as in the system 100 of FIG. 3), the sample loop 225, the sample volume 260, and/or restriction 270. The equilibration valve 265 may be a 3-way, 2-position switching valve with a first position connecting the second conduit 220 (and/or other components in the sample flow path such as the sample loop 225, the sample volume 260, the first conduit 205, etc.) to the second pump 305 and a second position connecting the second conduit 220 (and/or other components in the sample flow path such as the sample loop 225, the sample volume 260, the first conduit 205, etc.) to vent (e.g. atmosphere). The equilibration valve 265 can be controlled (e.g., switched between the first position and the second positions) using the same control logic as the valve 203. This can allow the sample loop 225 to be connected to the second pump 305 at the same time (e.g., simultaneously) as the sample valve 210 is opened during the sampling process. Additionally, using the same control logic for the equilibration valve 265 and the valve 203 can allow the sample valve 210 to close at the same time (e.g., simultaneously) as the sample loop 225 is disconnected from the second pump 305.

A fifth option shown in FIG. 4 vents the control flow path for the injection valve 240 to atmospheric pressure rather than to the second pump 305 (or the first pump 230 if two pumps are used for controlling the valves and filling the sample loop as in the system 100 of FIG. 3) during opening of the injection valve 240. Venting the control flow path for the injection valve 240 to atmospheric pressure rather than to the second pump 305 can allow the injection valve 240 to be opened more stably, keeping the injection time consistent, thereby reducing the need to calibrate the system 100 across a range of sample pressures.

The additional options shown in FIG. 4 can be combined in part or in whole to modify either of the gas chromatography systems illustrated in FIGS. 2-3.

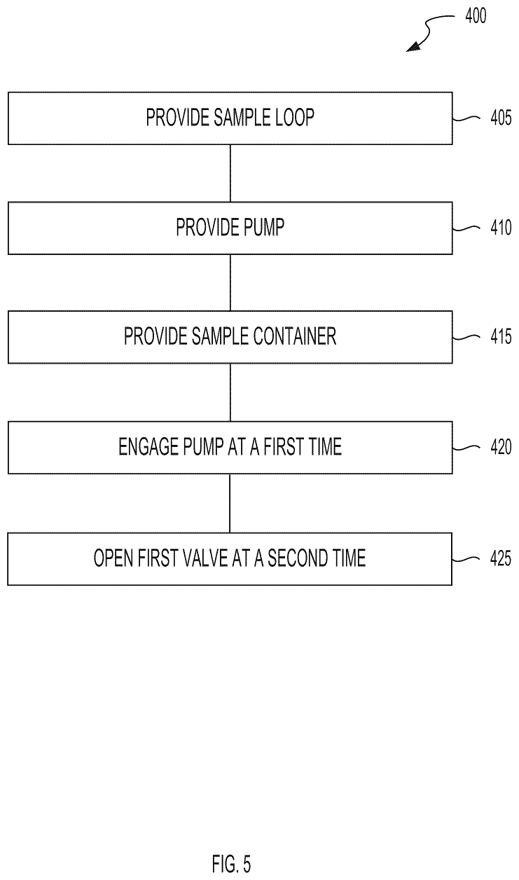

FIG. 5 is a schematic flow diagram illustrating a method 400 for analysis of samples. The method 400 can be for a gas chromatography system. The method 400 can be used for negative pressure sampling (e.g., sampling a sample stored at a negative pressure). The method 400 can be used for positive pressure sampling (e.g., sampling a sample stored at a positive pressure). The method can be used for both negative pressure samples and positive pressure samples at the same time. The method 400 can include providing a sample loop (e.g., sample loop 225) (BLOCK 405). The method 400 can include providing a pump (e.g., first pump 230) (BLOCK 410). The method 400 can include providing a sample container (e.g., sample container 245) (BLOCK 415). The method 400 can include engaging the pump at a first time (BLOCK 420). The method 400 can include opening a first valve (e.g., sample valve 210) at a second time (BLOCK 425).

The method 400 can include providing the sample loop (BLOCK 405). The sample loop can be disposed between the first valve and a second valve (e.g., pump valve 215). The first valve can include a membrane valve. A sensor can be disposed between the sample container and the first valve. The method 400 can include filling the sample loop with the sample (e.g., sample 217). For example, the sample loop can be filled with the sample subsequent to opening the first valve.

The method 400 can include providing the pump (BLOCK 410). The pump can include the first pump 230. The pump can be disposed downstream of the second valve. The pump can be fluidically connected with the sample loop during the pre-evacuation process. The pump can be fluidically connected with the sample loop during the sampling process. For example, the pump can be fluidically connected with the sample loop when the sample loop is being filled with the sample.

The method 400 can include providing the sample container (BLOCK 415). The sample container can be disposed upstream of the first valve. The method 400 can include determining, by one or more sensors, a pressure of the sample in the sample container. The sensor can receive one or more pressure values of the sample container. The pressure of the gas inside the sample container can be measured by a sensor.

The method 400 can include engaging the pump at a first time (BLOCK 420). The pump can be engaged (e.g., turned on) at the first time to modify a pressure inside the sample loop from a first pressure to a second pressure. The first time can include the instantaneous time when the pump is turned on. The first pressure can be greater than or equal to ambient pressure. The first pressure can be greater than or equal to the pressure in the sample container. The second pressure can be less than the first pressure. The second pressure can be greater than or equal to vacuum pressure. The second pressure can be less than ambient pressure. The second pressure can be less than or equal to the pressure in the sample container.

The pump can be engaged to reduce the pressure inside the sample loop. The pressure inside the sample loop can be the first pressure at a time before the first time. The pressure inside the sample loop can be the second pressure at a time after the first time. The pump can be engaged before the first valve is opened. The pump can be used to reduce the pressure in the sample loop such that the gas does not flow into the sample container upon opening the first valve. The pump can be used to remove the gas in the first conduit such that the gas does not flow into the sample container upon opening the first valve.

The method 400 can include opening the first valve at a second time (BLOCK 425). For example, the method 400 can include opening the first valve at the second time to flow the sample through the first valve. The first valve can transition from a closed state to an open state at the second time (e.g., the first valve can be closed at the first time and open at the second time). The sample can be disposed in the sample container at the first time. The sample can be disposed in the sample container before the second time. Beginning from the second time, some of sample can flow into the sample loop. The first valve can be opened at the second time to flow the sample through the first valve. The sample can flow to the sample loop. The sample loop can be filled with the sample. For example, the sample loop can be filled with enough sample such that the column can receive a sufficient amount of sample. The first valve can be open for a time sufficient to fill the sample loop with sample. The time sufficient to fill the sample loop with sample can depend on the pump, the pressure of the sample, the volume of the sample loop, the type of sample, and properties of the sample (e.g., viscosity). The second time can be subsequent to the first time. For example, the second time can occur at least 5 seconds after the first time. The pressure inside the sample loop can be the second pressure at the second time.

The pump can remain fluidically connected with the sample loop when the first valve is opened. The pump can remain fluidically connected with the sample loop at the second time. The pump can remain turned on at the second time. The pump can be turned on at the first time and remain turned on at the second time. The pump can remain turned on after the second time. The method 400 can include delayed opening of the first valve. For example, the first valve can be opened after the pump has been engaged. This can allow enough time for the pump to reduce the pressure of the sample loop to be less than the pressure of the sample container before sampling occurs.

The first valve can be opened after the pump is engaged. For example, the first valve can be opened after the pump has been engaged for a period of time sufficient to lower the pressure of the sample loop to a pressure below the pressure of the sample container. The first valve can be opened after the pump has been engaged for at least 5 seconds. For example, the first valve can be opened after the pump has been engaged for at least 5 seconds, at least 10 seconds, at least 20 seconds, or at least 30 seconds. The pump can stay engaged after the first valve is opened. The first valve can be opened after the pressure in the sample loop is less than the pressure of the sample inside the sample container. The pump can be turned on or off and the first valve can be opened or closed based on data obtained from one or more pressure sensors. The pump can be engaged and the sample valve can stay closed until the pressure in the sample loop is less than or equal to the pressure in the sample container. If the pressure in the sample loop is less than the pressure in the sample container, this can ensure that no gases flow (e.g., backflow) from the sample loop into the sample container, which would potentially contaminate and/or dilute the sample in the sample container. Contamination or dilution of the sample can occur when gases downstream of the sample loop flow back into the sample loop or to a location where, after being pressurized by the carrier gas, contaminated or diluted sample is injected into the column. The location could be between the sample loop and the second valve and can depend on the pressure of the sample, the pressure of the system, the injection time, and/or the sample type.

If the pressure of the sample loop and/or sample container is not directly measured using the one or more pressure sensors, the sample valve can be opened after the pump has been engaged for a period of time sufficient to reduce the pressure of the sample loop to at or below the pressure in the sample container. The period of time can be based on prior experimentation or knowledge of the parameters of the GC system 100. The period of time can be sufficient to avoid contamination of the sample loop.

The sample container can have a third pressure. The third pressure can be less than ambient pressure. The third pressure can be equal to or greater than ambient pressure. The third pressure can be less than the pressure of the sample loop. For example, the sample container can have a third pressure less than a pressure of the sample loop at the first time. The second pressure can be less than the third pressure. The third pressure can be less than the first pressure. For example, the pressure of the sample loop can be less than the pressure of the sample container such that the sample flows from the sample container to the sample loop. The pressure of the sample loop can be less than the pressure of the sample container before the first valve is opened. The first valve can be opened while the pump is engaged. Opening the first valve after and while the pump is engaged can prevent the sample in the sample container from being diluted (e.g., reduced in concentration) and/or contaminated (e.g., mixed with other compounds, back mixed) by downstream gases (e.g., residual tail gas). Downstream gases can include gases downstream of the sample container and/or first valve.

The method 400 can include engaging a second pump. The second pump can open the first valve. The second pump can be engaged to open the first valve. The second pump can be used to open the first valve if the sample in the sample container is below the threshold pressure. The second pump can be engaged responsive to a determination that a pressure of the sample is less than the threshold pressure. The determination can be made using data from one or more sensors. The second pump can be engaged responsive to a determination that a pressure of the sample in the sample container is less than the threshold pressure. The threshold pressure can be in a range of −22 kPa to −27 kPa. For example, the threshold pressure can be −22 kPa, −23 kPa, −24 kPa, −25 kPa, −26 kPa, or −27 kPa. If the pressure of the sample is below the threshold pressure, the second pump can be used to open the first valve. The second pump can be engaged responsive to the determination that the first valve is closed. The method 400 can include closing the first valve using pressurized carrier gas.

The method 400 can include providing a fourth conduit (e.g., fourth conduit 310). The fourth conduit can be disposed between the second pump and the first valve. The second pump can be used to open the first valve. Pressurized carrier gas can be used to close the first valve. For example, the control flow path can be switched to carrier gas to pressurize the control path and close the first valve. A control gas can flow through the fourth conduit. The control gas can be part of a control flow path. The sample can be part of a sample flow path. The control flow path can be fluidically disconnected from the sample flow path. For example, a gas used to control the first valve can flow through the fourth conduit. The control gas can flow from the first valve to the second pump.

The method 400 can include closing the first valve. For example, the first valve can be closed at a third time. The third time can be subsequent to the second time. The third time can be subsequent to the first time. The first valve can be closed after a sufficient amount of the sample has flowed into the sample loop. The first valve can be closed to prevent additional sample from flowing into the sample loop. The first valve can be closed after the sample loop is filled. For example, the first valve can be closed after the sample loop is filled with the sample. Closing the first valve can prevent the sample from flowing from the sample loop into the sample container. Closing the first valve can prevent the sample from flowing from the sample container to the sample loop. Pressurized gas, such as the carrier gas, can be used in the valve control flow path to close the first valve. The first valve can be opened after the pump has been in operation for a period of time (e.g., a non-zero time).

The method 400 can include opening a third valve (e.g., inject valve 240). The third valve can be opened at a fourth time. The fourth time can be subsequent to the third time. The third time can be subsequent to the second time. The third time can be subsequent to the first time. The third valve can be opened at the same time the first valve is closed. The third valve can be opened after the first valve is closed. The third valve can be opened at the time the second valve is switched from fluidically connecting the sample loop with the pump to fluidically connecting the sample loop with the carrier gas source (e.g., carrier gas source 110). The third valve can be opened before or after the second valve is switched from fluidically connecting the sample loop with the pump to fluidically connecting the sample loop with the carrier gas source. The third valve can be opened to allow the sample to flow to the column.

The second valve can be positioned such that the carrier gas source is fluidically connected with the sample loop at a fifth time subsequent to the third time and prior to the fourth time. The second valve can be positioned such that the carrier gas source is fluidically connected with the sample loop before the third valve is opened. For example, the second valve can be switched from fluidically connecting the pump and the sample loop to fluidically connecting the carrier gas source and the sample loop. The second valve can be positioned such that the carrier gas source is fluidically connected with the sample loop at a time subsequent to the second time. The second valve can be open to the first pump at the first time. For example, the second valve can be open to the first pump such that the first pump is fluidically connected with the sample loop at the first time. The second valve can be in a state in which the first pump is fluidically connected with the sample loop at the first time. The second valve can be in a state in which the sample loop is not fluidically connected with the carrier gas source at the first time.

The method 400 can include flowing carrier gas through the sample loop. The carrier gas can be flowed through the sample loop to flow the sample to the column. The carrier gas can flow through the third valve. The carrier gas can move the sample through the sample loop and the third valve. The second valve can be switched such that the carrier gas can flow from the pressurized gas source to the sample loop. The carrier gas can push the sample onto the column. For example, the carrier gas can push the sample through the sample loop and onto the column. The carrier gas source can be fluidically connected with the sample loop during the injection process.

The method 400 can include providing a sample cache, a two-position three-way valve, and/or a flow resistance downstream of the second valve. For example, the two-position three-way valve can be downstream of the sample cache. The flow resistance can be downstream of the two-position three-way valve and the sample cache. The method 400 can include providing a fourth valve. The fourth valve can be downstream of the third valve. The fourth valve can be vented to atmosphere.

A non-transitory computer-readable medium can be for or used with a gas chromatography system. The gas chromatography system can include a sample loop disposed between a first valve and a second valve. The gas chromatography system can include a pump disposed downstream of the second valve. The gas chromatography system can include a sample container disposed upstream of the first valve. The medium can have computer-readable instructions stored thereon that, when executed by at least one controller, cause the at least one controller to engage the pump at a first time to modify a pressure inside the sample loop from a first pressure to a second pressure less than the first pressure. The second valve is positioned such that the pump is fluidically connected with the sample loop at the first time. The at least one controller can open the first valve at a second time subsequent to the first time to flow a sample through the first valve into the sample loop. The second time can occur at least 5 seconds after the first time. The pump can be configured to remain fluidically connected to the sample loop and turned on at the second time. The at least one controller can delay the opening of the first valve such that the first valve is opened after and while the pump is engaged. The at least one controller can offset the time of opening of the first valve and the time of engaging of the pump.

In some embodiments, the pump is a first pump and the first valve is a membrane valve. The at least one controller can be configured to engage a second pump to open the first valve. The at least one controller can be configured to engage the second pump responsive to a determination that a pressure of the sample in the sample container is less than a threshold pressure. The at least one controller can be configured to determine that the pressure of the sample in the sample container is less than the threshold pressure based on one or more sensor values (e.g., pressure sensor values). The user can determine that the pressure of the sample in the sample container is less than the threshold pressure based on specifications that the user has received about the instrument and based on the user's knowledge of the sample pressure. The user can implement a mode of operation that includes engaging the second pump. The at least one controller can be configured to determine a pressure of the sample in the sample container.

The at least one controller can be configured to close the first valve at a third time subsequent to the second time. The at least one controller can be configured to open a third valve at a fourth time subsequent to the third time. The at least one controller can be configured to flow carrier gas through the sample loop to flow the sample to a column. The second valve can be positioned such that a carrier gas source is fluidically connected with the sample loop at a fifth time subsequent to the third time and prior to the fourth time. The second valve can be positioned such that the carrier gas source is fluidically connected with the sample loop before the third valve is opened. The sample container can have a third pressure less than a pressure of the sample loop. For example, the sample container can have a third pressure less than a pressure of the sample loop at the first time.

In some embodiments, a sample cache and a two-position three-way valve are provided downstream of the second valve. A flow resistance can be provided downstream of the two-position three-way valve. In some embodiments, a fourth valve cam be provided downstream of the third valve, and the fourth valve is vented to atmosphere.

Any references to implementations or elements or acts of the systems and methods herein referred to in the singular can include implementations including a plurality of these elements, and any references in plural to any implementation or element or act herein can include implementations including only a single element. References in the singular or plural form are not intended to limit the presently disclosed systems or methods, their components, acts, or elements to single or plural configurations. References to any act or element being based on any information, act or element may include implementations where the act or element is based at least in part on any information, act, or element.

While operations can be depicted in the drawings in a particular order, such operations are not required to be performed in the particular order shown or in sequential order, and all illustrated operations are not required to be performed. Actions described herein can be performed in a different order.

Any implementation disclosed herein may be combined with any other implementation, and references to “an implementation,” “some implementations,” “an alternate implementation,” “various implementations,” “one implementation” or the like are not necessarily mutually exclusive and are intended to indicate that a particular feature, structure, or characteristic described in connection with the implementation may be included in at least one implementation. Such terms as used herein are not necessarily all referring to the same implementation. Any implementation may be combined with any other implementation, inclusively or exclusively, in any manner consistent with the aspects and implementations disclosed herein.

References to “or” may be construed as inclusive so that any terms described using “or” may indicate any of a single, more than one, and all of the described terms. References to at least one of a conjunctive list of terms may be construed as an inclusive OR to indicate any of a single, more than one, and all of the described terms. For example, a reference to “at least one of ‘A’ and ‘B’” can include only ‘A’, only ‘B’, as well as both ‘A’ and ‘B’. Elements other than ‘A’ and ‘B’ can also be included.

The systems and methods described herein may be embodied in other specific forms without departing from the characteristics thereof. The foregoing implementations are illustrative rather than limiting of the described systems and methods.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

The systems and methods described herein may be embodied in other specific forms without departing from the characteristics thereof. The foregoing implementations are illustrative rather than limiting of the described systems and methods. Scope of the systems and methods described herein is thus indicated by the appended claims, rather than the foregoing description, and changes that come within the meaning and range of equivalency of the claims are embraced therein.

1. A method for a gas chromatography system, comprising:
providing a sample loop disposed between a first valve and a second valve;
providing a pump disposed downstream of the second valve;
providing a sample container disposed upstream of the first valve;
engaging the pump at a first time to modify a pressure inside the sample loop from a first pressure to a second pressure less than the first pressure, wherein the second valve is positioned such that the pump is fluidically connected with the sample loop at the first time; and
opening the first valve at a second time subsequent to the first time to flow a sample through the first valve into the sample loop, wherein the pump is configured to remain fluidically connected to the sample loop and turned on at the second time.

2. The method of claim 1, wherein the pump is a first pump and the first valve is a membrane valve, the method comprising:
engaging a second pump to open the first valve.

3. The method of claim 2, comprising:
engaging the second pump responsive to a determination that a pressure of the sample in the sample container is less than a threshold pressure.

4. The method of claim 3, wherein the threshold pressure is in a range of −22 kPa to −27 kPa.

5. The method of claim 2, comprising:
closing the first valve using pressurized carrier gas.

6. The method of claim 1, comprising:
closing the first valve at a third time subsequent to the second time;
opening a third valve at a fourth time subsequent to the third time; and
flowing carrier gas through the sample loop to flow the sample through the third valve to a column,
wherein the second valve is positioned such that a carrier gas source is fluidically connected with the sample loop at a fifth time subsequent to the third time and prior to the fourth time.

7. The method of claim 6, wherein a fourth valve is provided downstream of the third valve, and the fourth valve is vented to atmosphere.

8. The method of claim 1, wherein the second time occurs at least 5 seconds after the first time.

9. The method of claim 1, comprising:
determining, by one or more sensors, a pressure of the sample in the sample container.

10. The method of claim 1, comprising:
filling, subsequent to opening the first valve, the sample loop with the sample.

11. The method of claim 1, wherein the sample container has a third pressure less than ambient pressure.

12. The method of claim 11, wherein, at the first time:
the second pressure is less than the third pressure, and
the third pressure is less than the first pressure.

13. The method of claim 1, wherein the sample container has a third pressure equal to or greater than ambient pressure.

14. The method of claim 1, wherein the sample container has a third pressure less than a pressure of the sample loop at the first time.

15. The method of claim 1, wherein:
the second valve is a 3-way, 2-position switching valve, and
the second valve is connected to a carrier gas source.

16. The method of claim 1, wherein a sample volume and a two-position three-way valve are provided downstream of the second valve.

17. The method of claim 16, wherein a flow resistance is provided downstream of the two-position three-way valve.

18. A non-transitory computer-readable medium for a gas chromatography system that comprises (1) a sample loop disposed between a first valve and a second valve, (2) a pump disposed downstream of the second valve, and (3) a sample container disposed upstream of the first valve, the medium having computer-readable instructions stored thereon that, when executed by at least one controller, cause the at least one controller to:
engage the pump at a first time to modify a pressure inside the sample loop from a first pressure to a second pressure less than the first pressure, wherein the second valve is positioned such that the pump is fluidically connected with the sample loop at the first time; and
open the first valve at a second time subsequent to the first time to flow a sample through the first valve into the sample loop, wherein the pump is configured to remain fluidically connected to the sample loop and turned on at the second time.

19. The non-transitory computer-readable medium of claim 18, wherein:
the pump is a first pump,
the first valve is a membrane valve, and
the at least one controller is configured to engage a second pump to open the first valve.

20. The non-transitory computer-readable medium of claim 19, wherein the at least one controller is configured to engage the second pump responsive to a determination that a pressure of the sample in the sample container is less than a threshold pressure.

21. The non-transitory computer-readable medium of claim 18, wherein the at least one controller is configured to:
close the first valve at a third time subsequent to the second time;
open a third valve at a fourth time subsequent to the third time; and
flow carrier gas through the sample loop to flow the sample through the third valve to a column,
wherein the second valve is positioned such that the pump is fluidically connected with a carrier gas source at a fifth time subsequent to the third time and prior to the fourth time.

22. The non-transitory computer-readable medium of claim 18, wherein the at least one controller is configured to:
determine a pressure of the sample in the sample container.

23. The non-transitory computer-readable medium of claim 18, wherein the sample container has a third pressure less than a pressure of the sample loop at the first time.

24. The non-transitory computer-readable medium of claim 18, wherein a sample volume and a two-position three-way valve are provided downstream of the second valve.

25. The non-transitory computer-readable medium of claim 24, wherein a flow resistance is provided downstream of the two-position three-way valve.

26. The non-transitory computer-readable medium of claim 21, wherein a fourth valve is provided downstream of the third valve, and the fourth valve is vented to atmosphere.

27. The non-transitory computer-readable medium of claim 18, wherein:
the pump is a first pump,
the first valve is a membrane valve, and
the at least one controller is configured to engage the first pump to open the first valve.

28. The method of claim 1, wherein the pump is a first pump and the first valve is a membrane valve, the method comprising:
engaging the first pump to open the first valve.
